(19) United States
(12) Patent Application Publication
(10) Pub. No.: US 2013/0058642 A1
(43) Pub. Date: Mar. 7, 2013

(54) METHOD AND SYSTEM FOR CONSERVING POWER IN AN OPTICAL NETWORK

(71) Applicant: Martin Bouda, Plano, TX (US)

(72) Inventor: Martin Bouda, Plano, TX (US)

(73) Assignee: FUJITSU LIMITED, Kawasaki-shi (JP)

(21) Appl. No.: 13/224,082

(22) Filed: Sep. 1, 2011

(51) Int. Cl. H04B 10/08

(52) U.S. Cl. 398/25

(57) ABSTRACT

In accordance with the present disclosure, a method for conserving power in an optical network comprises determining a signal transmission capability of a first network element optically coupled to a second network element over an optical network. The first network element is configured to transmit an optical signal to the second network element over a path associated with the optical network. The method further comprises determining a transmission requirement of the path between the first and second network elements and determining a difference between the transmission capability and the transmission requirement. Additionally, the method comprises changing at least one of error correction and modulation associated with the optical signal transmitted based on the difference between the transmission capability and the transmission requirement, to reduce power consumption of at least one of the first network element and the second network element.

### TECHNICAL FIELD

The present disclosure relates generally to optical networks and more particularly to a system and method for conserving power in an optical network.

### BACKGROUND

Telecommunications systems, cable television systems and data communication networks use optical networks to rapidly convey large amounts of information between remote points. In an optical network, information (“traffic”) is conveyed in the form of optical signals through optical fibers.

Optical networks may be designed to transmit traffic over a longer distance than the distance that the traffic is actually being transmitted. Optical networks may additionally be designed to transmit traffic at a higher data rate than needed. This unused “margin” or ability to transmit traffic at a higher rate or over a longer distance than needed may cause components within the optical networks to consume more power than is necessary to effectively convey traffic throughout the networks.

### SUMMARY

In accordance with the present disclosure, a method for conserving power in an optical network comprises determining a signal transmission capability of a first network element optically coupled to a second network element over an optical network. The first network element is configured to transmit an optical signal to the second network element over a path associated with the optical network. The method further comprises determining a transmission requirement of the path between the first and second network elements and determining a difference between the transmission capability and the transmission requirement. Additionally, the method comprises changing at least one of error correction and modulation associated with the optical signal transmitted based on the difference between the transmission capability and the transmission requirement, to reduce power consumption of at least one of the first network element and the second network element.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates an embodiment of an optical network configured to conserve power;

FIG. 2 illustrates a system configured to conserve power by adjusting the modulation of an optical signal;

FIG. 3 illustrates an example system configured to conserve power by adjusting error correction of an optical signal; and

FIG. 4 illustrates a method for conserving power by a network element.

### DETAILED DESCRIPTION

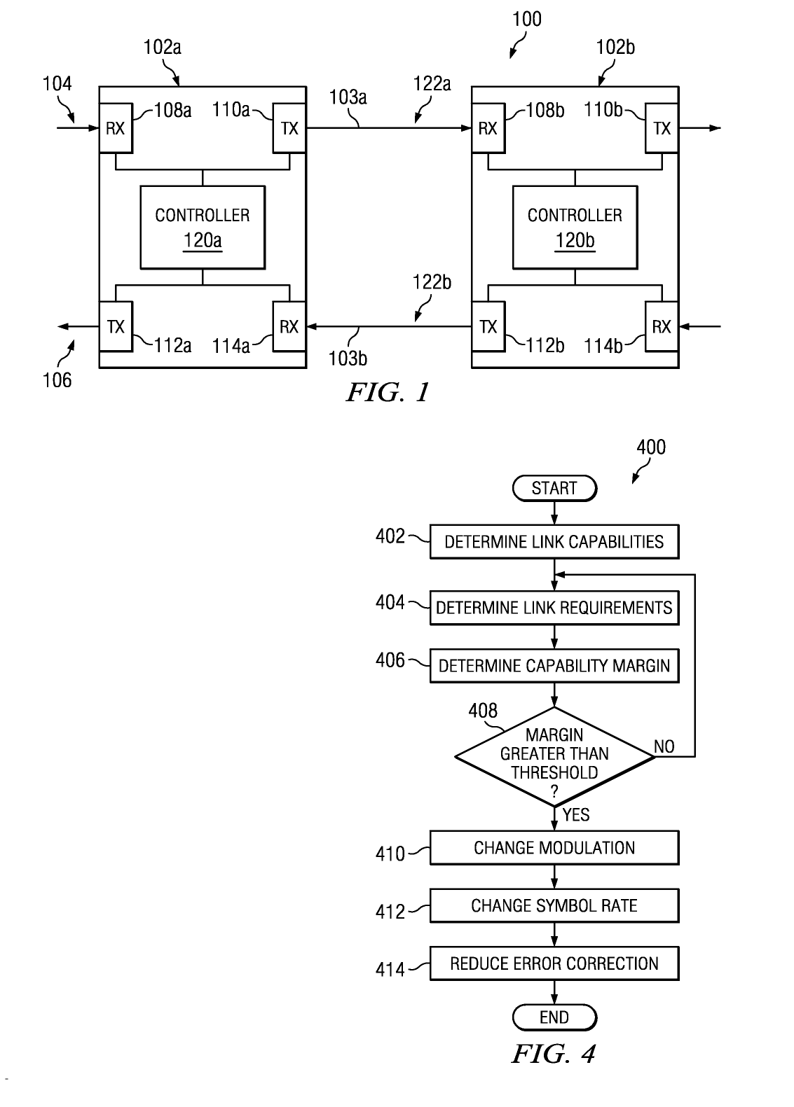

FIG. 1 illustrates an embodiment of an optical network 100 configured to conserve power by modifying the transmission capabilities of network elements included in network 100 according to the transmission needs of network 100. Network 100 may include network elements 102 configured to communicate data or signals between each other via optical fibers 103. As discussed in further detail below, network elements 102 may be configured to reduce power consumption when the transmission margin (ability to transmit information over distances and/or at a higher rate than needed) between network elements 102 is sufficiently high. Power consumption may be reduced by modifying error checking, symbol transmission rates and modulation formats based on distance and traffic requirements. When distance and traffic requirements are reduced, at least one of error checking, symbol transmission rates and modulation formats may be reduced to reduce power consumption within network 100.

Optical network 100 may comprise a point-to-point optical network with terminal nodes, a ring optical network, a mesh optical network, or any other suitable optical network or combination of optical networks. Optical fibers 103 may comprise thin strands of glass capable of communicating the signals over long distances with very low loss. Optical fibers 103 may comprise any suitable type of fiber, such as a Single-Mode Fiber (SMF), Enhanced Large Effective Area Fiber (ELEAF), or a TrueWave® Reduced Slope (TW-RS) fiber.

Information transmitted, stored, or sorted within network 100 may be referred to as “traffic.” Such traffic may comprise optical or electrical signals configured to encode audio, video, textual, or any other suitable data. The data may also be real-time or non-real-time. Traffic may be communicated via any suitable communications protocol, including, without limitation, the Open Systems Interconnection (OSI) standard and Internet Protocol (IP). Additionally, traffic may be structured in any appropriate manner including, but not limited to, being structured in frames, packets, or an unstructured bit stream.

In some embodiments, traffic may travel from one network element 102 (e.g., network element 102a) to another network element 102 (e.g., network element 102b) along an eastward path 104 or a westward path 106. Eastward path 104 and westward path 106 may include network elements 102a and 102b, one or more fibers 103, and zero, one, or more intermediate network elements (not expressly shown). Accordingly, network elements 102a and 102b may be configured to transmit traffic, receive traffic, or both via eastward path 104 and westward path 106.

Although eastward path 104 and westward path 106 are labeled as such, the labels do not mean that the paths are actually travelling east and west. The labels are merely to indicate that traffic on eastward path 104 is being sent in an opposite direction of traffic being sent on westward path 106.

A “link” may describe the communicative connection between two adjacent network elements 102. For example, the communicative connection between network elements 102a and 102b over eastward path 104 via fiber 103a may comprise a link 122a. Additionally, the communicative connection between network elements 102a and 102b over westward path 106 via fiber 103b may comprise a link 122b. A path between network elements may comprise one or more links. Links may comprise multiple spans of fiber with optical amplifiers placed between the spans.

Information may be transmitted and received through network 100 (e.g., traffic transmitted between network elements 102a and 102b) by modulation of one or more wavelengths of light to encode the information on the wavelength. In some instances a wavelength configured to carry information may be referred to as an “optical channel” or a “channel.” Each channel may be configured to carry a certain amount of information through optical network 100.

To increase the information carrying capabilities of optical network 100, multiple signals transmitted at multiple channels may be combined into a single optical signal. The process of communicating information at multiple channels of a single optical signal is referred to in optics as wavelength division multiplexing (WDM). Dense wavelength division multiplexing (DWDM) refers to the multiplexing of a larger (denser) number of wavelengths, usually greater than forty, into a fiber. WDM, DWDM, or other multi-wavelength transmission techniques are employed in optical networks to increase the aggregate bandwidth per optical fiber. Without WDM or DWDM, the bandwidth in optical networks may be limited to the bit-rate of solely one wavelength. With more bandwidth, optical networks are capable of transmitting greater amounts of information. Optical network 100 may be configured to transmit disparate channels using WDM, DWDM, or some other suitable multi-channel multiplexing technique, and to amplify the multi-channel signal.

Besides the number of channels carried through a fiber at one time, another factor that affects how much information can be transmitted over an optical network may be the bit rate of transmission. The greater the bit rate, the more information that may be transmitted in a same amount of time. In some instances the bit rate may be increased by increasing the amount of information (e.g., bits) transmitted with each symbol. Symbols are transmitted at the so-called Baud rate or symbol rate, which equals the bit rate if each symbol represents one bit only. Various modulation formats may be used to modulate information onto a symbol with various amounts of information being modulated onto a symbol depending on the modulation formats.

Symbols may carry more bits by modulating the optical field of the beam in more complex ways such as modulating information on two orthogonal polarization states independently, and by increasing the number of states or levels of intensity or phase of the modulated beam.

For example, with a dual polarization quadrature phase shift keying (DP-QPSK) modulation technique, information may be modulated onto two polarization states of an optical beam whereas in a single polarization modulation (e.g., QPSK modulation) information may be modulated onto a single polarization state. Accordingly, less information may be modulated onto a symbol with a single polarization modulation scheme than a dual polarization modulation scheme.

An alternate example is a polarization 16 Quadrature Amplitude Modulation (16-QAM) modulation technique generated using a modulator driven by four independent electrical information or tributary signals. By supplying only two signals the modulation scheme becomes 4-QAM with half of the information capacity per symbol.

Another example is a QPSK signal generated using a modulator driven by two independent information or tributary signals. By providing only one signal the modulation scheme may turn into Binary Phase Shift Keying (BPSK) format carrying half the information per symbol. A dual-polarization modulation scheme or a more complex modulation scheme may also require the use of more components (e.g., a driver for each modulated polarization state, a receiver for each modulated polarization state, a driver for each optical modulator subcomponent, and a receiver for one or more optical signals obtained by appropriate decomposition of the total optical field into tributaries) and more processing power (e.g., digital signal processing (DSP) for each modulated polarization state or additional tributary signal) than a single polarization modulation scheme. Accordingly, a dual-polarization modulation scheme may consume more power than a single polarization modulation scheme.

Additionally, a more complex modulation scheme (e.g., QPSK compared to BPSK or 16-QAM compared to 4-QAM) with a larger number of optical phase or amplitude levels may be such that a receiver receiving the optical signal may be less tolerant to noise due to the reduced distance between symbol states. To compensate for the reduced noise tolerance, a larger number of error correcting schemes may be implemented within network 100. The error correcting schemes may be implemented by various components or processing schemes that consume power. Therefore, as modulation schemes decrease noise tolerance, more power may be consumed by more sophisticated error correction techniques. Accordingly, a modulation scheme with a low noise tolerance may consume more power than another modulation scheme with a higher noise tolerance.

Another method of increasing the bit rate of an optical network may be to increase the symbol rate of an optical network, that is, the time per symbol is reduced. As the symbol rate increases, the amount of information (e.g., bits) transmitted over a period of time may also be increased. However, an increased symbol rate may also introduce a lower tolerance to noise by the receiving components of an optical network due to certain fiber impairment effects. Therefore, increased symbol rates in this scheme may also require increased error correction and power consumption.

Optical networks may also be configured to transmit information between network elements separated over a relatively large distance. As the distance between network elements increases, the amount of noise introduced to signals travelling between the two elements may increase. As the noise introduced by distance increases, more sophisticated error correction schemes that may consume more power may also increase. Accordingly, power consumption, capacity and distance may be traded-off against each other.

Network elements 102 may be configured to modify symbol rates, modulation techniques and error correction schemes, or any combination thereof to conserve power, instead of transmitting traffic at fixed symbol rates, fixed modulation schemes, and fixed error correction designed for a fixed transmission and distance capabilities as is done in conventional networks. In some embodiments, network elements 102 of network 100 may be configured to modify symbol rates, modulation schemes, or any combination thereof based on traffic transmission requirements and distances. Therefore, in instances where the traffic requirements and distance may allow, network elements 102 may convey traffic at symbol rates and/or modulation techniques that may reduce energy consumption. This is in contrast to conventional networks where the fixed symbol rates, fixed modulation schemes and fixed distance capabilities may be unnecessarily high for the traffic transmission requirements—which may lead to unnecessary power consumption. Further, network elements 102 may be configured to reduce error correction based on lower symbol rates, simpler modulation schemes and shorter distances, which may also reduce power consumption.

A network element 102 may be any system, apparatus or device that may be configured to route traffic through, to, or from a network. Examples of network elements 102 include routers, switches, reconfigurable optical add-drop multiplexers (ROADMs), wavelength division multiplexers (WDMs), access gateways, intra-connected switch pair, endpoints, softswitch servers, trunk gateways, or a network management system.

Network elements 102 may include various components including, but not limited to, transmitters 110 and 112, receivers 108 and 114, and controllers 120 configured to modify the power consumption of network elements 102a and 102b based on traffic requirements of links 122a and 122b between network elements 102a and 102b. Additionally, these components may be configured to modify the power consumption of network elements 102a and 102b based on the physical distance between network elements 102a and 102b.

Transmitters 110 and 112 may comprise any system, apparatus or device configured to convert an electrical signal into an optical signal and transmit the optical signal. For example, transmitters 110 and 112 may each comprise a laser and a modulator configured to receive electrical signals and modulate the information contained in the electrical signals onto a beam of light produced by the laser at a particular wavelength and transmit the beam carrying the signal throughout the network. In instances where network 100 may transmit a WDM signal, network elements 102 may include at least one transmitter 110 and 112 associated with each channel of eastward path 104 and westward path 106 respectively.

Receivers 108 and 114 may be configured to receive signals transmitted in a particular wavelength or channel and process the signals for the information that they contain (e.g., decode the modulation to extract the information). Accordingly, in instances where network 100 may transmit a WDM signal, network elements 102 may include at least one receiver 108 and 114 for every channel of eastward path 104 and westward path 106 respectively.

As discussed further below, network elements 102, transmitters 110 and 112, and receivers 108 and 114 may be configured to perform power saving techniques such as reduced error correction, reduced bit rate transmission and simplified modulation techniques based on path traffic requirements and path distances of optical signals associated with network elements 102.

Controllers 120 may include any system, device or apparatus configured to control the operations of one or more components included in network element 102. For example, controllers 120 may be communicatively coupled to receivers 108 and 114 and transmitters 110 and 112, or any combination thereof. Controllers 120 may be configured to receivers 108 and 114, transmitters 110 and 112, or any combination thereof, to perform power saving techniques.

Controllers 120 may include hardware, software, firmware, or any combination thereof. Examples of a controller 120 include one or more computers, one or more microprocessors, or one or more applications. In particular embodiments, controllers 120 may include computer readable media encoded with a computer program, software, computer executable instructions, or instructions capable of being executed by a computer. The computer readable media may perform the operations of controllers 120 or components associated with and controlled by controllers 120. Controllers 120 may also include memory that may comprise one or more tangible, computer-readable, or computer executable storage medium that stores information. Examples of memory include computer memory (e.g., Random Access Memory (RAM), Read Only Memory (ROM)), mass storage media (e.g., a hard disk), removable storage media (e.g., a Compact Disk (CD), a Digital Video Disk (DVD), or a flash memory drive), database or network storage (e.g., a server), or other computer-readable medium.

Although network elements 102 are depicted with one controller 120, the disclosure should not be limited to such. Network elements 102 may include multiple controllers 120 that may perform various operations. For example, receivers 108 and 114, and transmitters 110 and 112 may each include one or more controllers 120 that may perform the operations of these components.

For power savings operations, controllers 120 may be configured to determine the transmission capabilities of network elements 102 and the links and/or paths associated with network elements 102. The transmission capabilities may include traffic transmitting and receiving capabilities of transmitters 110 and 112, and receivers 108 and 114 associated with network elements 102. The transmission capabilities may also include the distance capabilities of network elements 102. For example, the traffic capabilities may indicate how much data transmitters 110 and 112, and receivers 108 and 114 may be capable of sending and receiving at any one time via an optical signal sent over a link or path. The traffic capabilities may accordingly be a function of symbol rate capabilities (how quickly symbols are sent) and modulation format capabilities (which may dictate how much data is modulated on each symbol) of transmitters 110 and 112, and receivers 108 and 114 with respect to optical signals transmitted and received by transmitters 110 and 112, and receivers 108 and 114.

The distance capabilities of network elements 102 may be related to the distance over which network elements 102 may be able to communicate a signal. The distance capabilities may be related to signal transmission power capabilities, modulation formats, error correction schemes, insertion loss, amplifier performance, dispersion compensation, etc., implemented by network elements 102, and optical amplification type and performance, fiber span length, insertion losses, capacity, fiber type, and dispersion management implemented in the link 122.

Controllers 120 may also be configured to determine the transmission requirements of eastward path 104 and westward path 106 and/or one or more links associated with eastward path 104 and westward path 106, such as links 122a and 122b. The transmission requirements may include traffic and distance requirements. The traffic requirements may indicate the amount of traffic that is actually transmitted over a path and/or link over a given period of time. The traffic requirements may accordingly indicate which symbol rates and modulation formats may be used to satisfy the traffic needs of a particular path and/or link. For example, a link that has a high level of traffic may need a faster symbol rate and/or modulation format that carries more data than a link with a lower level of traffic. Controllers 120 may determine the traffic requirements based on historical data, data received from a network supervisor of network 100 or based on the configuration of one or more receivers 108 or 114 or the configuration of one or more transmitters 112 or 110 or a combination thereof.

Controllers 120 may alternatively determine the transmission requirements based on the quality of data received at one of receivers 108b or 114a, the quality of transmission at an intermediate point of paths 104 and 106, and one or more links associated with paths 104 and 106 (e.g., links 122a and 122b), or any combination thereof. Controllers 120 may determine the configuration of transmitters 110 or 112 and receivers 108 or 114 to both meet all transmission requirements and minimize the power consumption of the nodes 102.

Controllers 120 may also be configured to approximately determine the transmission distance requirements associated with eastward path 104, westward path 106 and/or one or more links 122a and 122b. The distance requirements may indicate the actual distance between a source network element and a receiving network element of a path (e.g., network elements 102a and 102b) and may accordingly indicate the propagation distance of signals travelling from the source node to the destination node via the path and/or one or more links. Based on the distance requirements, controllers 120 may be configured to determine modulation, data rate and error correction schemes required to transmit signals over that distance. Controllers 120 may determine the configuration of transmitters 110 or 112 and receivers 108 or 114 to both meet all transmission requirements including transmission distance and minimize the power consumption of the nodes 102.

For example, controllers 120 may be configured to determine the propagation distance of signals travelling through links 122a and 122b. Based on the approximated distance of links 122a and 122b, controllers 120 may determine modulation, data rate and error correction schemes required to transmit signals over that distance such that traffic may be effectively transmitted over links 122a and 122b. Alternatively, controllers 120 may be informed by the network management or by the user of the optical length of the path in links 122a and 122b.

Controllers 120 may be configured to compare the transmission capabilities of a path and/or link with the transmission requirements of the path and/or link and determine the difference between the two. In some instances the transmission capabilities may surpass the transmission requirements, thus creating a transmission capability margin. The transmission capability margin may indicate that the path and/or link may be able to transmit signals with a higher capability than what is actually required.

For example, the actual transmission distance over a link may be shorter than the distance over which the network elements associated with the link may be capable of transmitting a signal. Thus a transmission distance margin may exist. As another example, the amount of traffic transmitted over a link (e.g., the amount of traffic transmitted and received by transmitters and receivers associated with that link) may be less than the amount of traffic that the link is capable of supporting (e.g., the amount of traffic that the transmitters, receivers and fibers associated with that link are able to support), therefore a traffic margin may exist. In other embodiments, the transmission capability margin may include a combination of a distance margin, a traffic margin or any other transmission parameter margin.

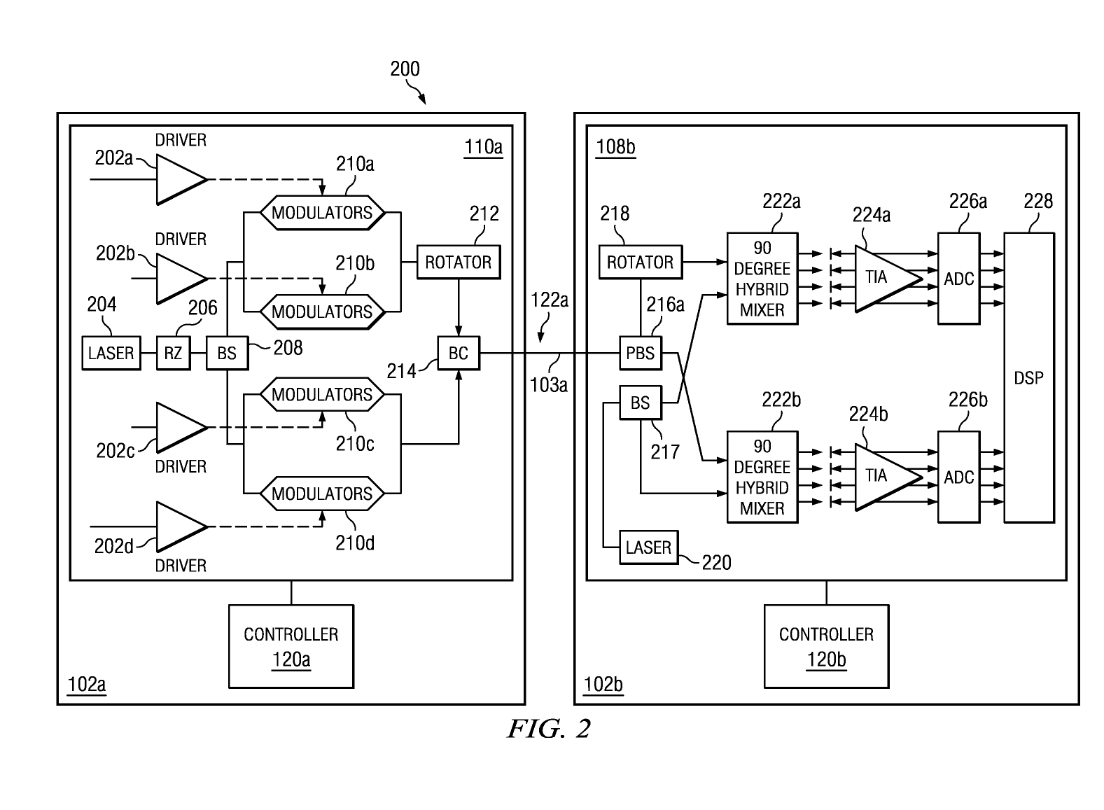

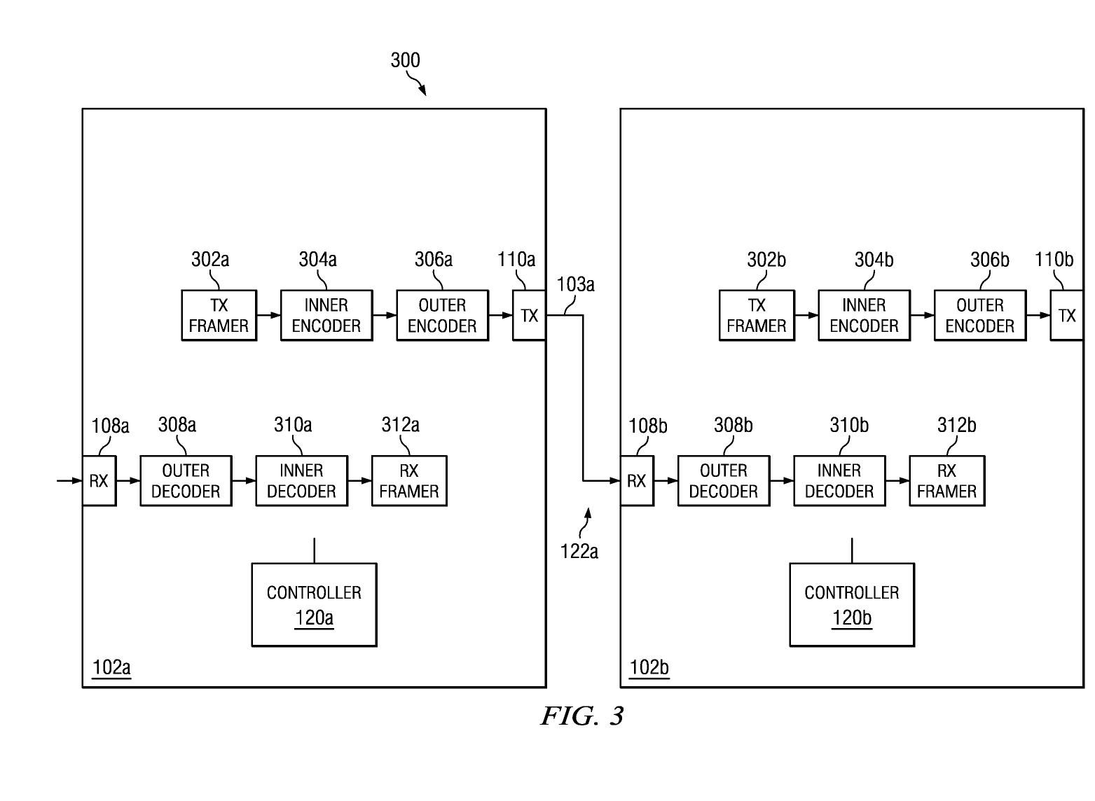

Controllers 120 may also be configured to determine whether the margin is substantially large enough that various power saving methods may be employed. Controllers 120 may determine the margin by employing capabilities of the receivers 108b or 114a to measure bit error rate or optical path characteristics, or transmitter characteristics, or other information provided by the user or the network, or combinations thereof. If the margin is substantially large enough, controllers 120 may direct network elements 102 to implement one or more power conservation methods. As discussed in further detail with respect to FIGS. 2 and 3, network elements 102 may implement power conservation techniques as instructed by controllers 120, based on the transmission determinations of controllers 120.

In some embodiments a controller 120 may determine that a power conservation scheme may be implemented for a particular link and may convey the power conservation scheme for that link to another controller 120 associated with the link, such that the transponders associated with the link implement the same power conservation method. In some embodiments, controller 120a may inform controller 120b that a change in modulation to save power may be done, and controller 120b may act accordingly instead of each controller 120 making a power saving determination. In alternative or the same embodiments, controller 120b may communicate the modulation change to controller 120a.

For example, controller 120a may determine that a power conservation scheme (e.g., change modulation of transmitted signal, simplify error correction, etc.) may be implemented for link 122a and may accordingly direct network element 102 to implement the scheme. Controller 120a may also communicate the scheme information to controller 120b such that controller 120b may direct network element 102 to implement the same power conservation scheme (e.g., receive signals having the new modulation, match error correction with transmitter, etc.). Controllers 120 may also execute transmission capability tests using test traffic.

In other instances, controllers 120a and 120b may be configured to implement the same power saving techniques (e.g., change in modulation) based on certain criteria such that both controllers implement the same technique or techniques at the same time.

In alternative embodiments, network 100 may include a network managing system communicatively coupled to network elements 102 and controllers 120 included in controllers 120. The network managing system may be configured to determine the transmission capabilities (e.g., traffic carrying capabilities and distance capabilities) of network elements 102 associated with the links and/or paths and may communicate that information to controllers 120. The network managing system may also be configured to determine the transmission requirements (e.g., traffic requirements and actual distance) of paths and/or links associated with network elements 102 and may communicate that information to controllers 120. In such embodiments, controllers 120 may be configured to determine transmission margins and power conservation schemes according to the information received from the network managing system. Controllers 120 may accordingly implement the determined power conservation schemes for the network elements 102.

In yet alternative embodiments, the network managing system may also determine the transmission margins and the power conservation schemes and may communicate that information to controllers 120. In such embodiments, controllers 120 may implement the power conservation schemes for network elements 102 as instructed by the network management system.

Modifications, additions, or omissions may be made to system 100 without departing from the scope of the disclosure. For example, although two network elements 102 are depicted, system 100 may include more or fewer than two network elements 102. Further, more or fewer paths may be included in network 100 than eastward and westward paths 104 and 106.

FIG. 2 illustrates an example system 200 configured to conserve power by adjusting the modulation of an optical signal. System 200 may include network elements 102a and 102b of FIG. 1 that may respectively include controllers 120a and 120b. As discussed in further detail below, in one embodiment, controllers 120a and 120b may be configured to determine whether or not the modulation of signals transmitted and received by network elements 102 may be changed to conserve power. Network elements 102a and 102b may be configured to modify the modulation to achieve power saving as instructed by controllers 120a and 120b respectively.

Network element 102a may include transmitter 110a of FIG. 1, and may also include transmitters 112a and receivers 108a and 114a (not expressly shown in FIG. 2) of FIG. 1. Transmitter 110a may be configured to modify the modulation of signals it transmits to conserve power when applicable. As discussed in further detail below, transmitter 110a may be configured to change from transmitting a DP-QPSK modulated signal to transmitting a QPSK modulated signal to conserve power.

However, any other change from a more complex modulation format to a less complex modulation format is also contemplated. For example, transmitter 110a may be configured to change from transmitting a DP-QPSK modulated signal to transmitting a 8-PSK signal to reduce power consumption and maximum transmission distance while maintaining same transmission capacity. The 8-PSK signal is generated by driving only two modulators 210a and 210b or 210c and 210d with a four-level (4-ASK) drive signal.

Network element 102a may include receiver 108b, and may also include receiver 114b and transmitters 110b and 112b (not expressly shown in FIG. 2) of FIG. 1. As discussed in further detail below, receiver 108b may be configured to modify operations associated with receiving a DP-QPSK signal to operations associated with receiving a single polarization QPSK or a single polarization 8-PSK signal to conserve power.

Transmitter 110a may include a laser 204 configured to generate a beam of light configured to have information modulated thereon such that the beam may carry traffic. Some embodiments of transmitter 110a may include a return to zero (RZ) pulse carver 206 coupled to laser 204 and configured to received the beam from laser 204. RZ carver 206 may be configured to implement a return-to-zero modulation technique to increase the maximum transmission distance. In alternative embodiments that do not include a return-to-zero modulation technique, transmitter 110a may not include RZ carver 206.

Transmitter 110a may also include a beam splitter (BS) 208 configured to receive the beam from laser 204 and split the beam into two beams having two different polarization states. BS 208 may be configured to direct the two beams to a plurality of phase modulators 210. In the present embodiment, BS 208 may be configured to direct one of the polarized beams to modulators 210a and 210b and the other polarized beam to modulators 210c and 210d. Alternatively a power splitter may be used instead of BS 208.

Phase modulators 210 may be configured to modulate information onto the beams of light. Each phase modulator 210 may be communicatively coupled to a driver 202 (e.g., phase modulator 210a may be communicatively coupled to driver 202a) and may be configured to modulate information as received from drivers 202 onto the beams. Modulators 210 may be configured to modulate the information onto the beams according to a phase shift keying (PSK) technique.

The modulated beams leaving modulators 210c and 210d may be combined and directed toward a beam combiner (BC) 214. The modulated beams leaving modulators 210a and 210b may be combined and directed toward a rotator 212. Rotator 212 may be configured to rotate the polarization of the beam associated with modulators 212a and 212b such that its polarization is orthogonal to the polarization of the beam associated with modulators 212c and 212d. Rotator 212 may direct the rotated beam toward BC 214.

BC 214 may be configured to combine the two modulated beams having different polarization states into a single beam that includes both polarization components. Alternatively, rotator 212 and BC 214 may be replaced by any other means to appropriately combine the modulated optical beams from modulator pairs 210a and 210b, and 210c and 210d into orthogonal polarizations. Accordingly, the combined beam may include two polarization components with data encoded thereon, such that the beam comprises a DP-QPSK modulated signal. After being combined by BC 214, the DP-QPSK signal may be transmitted to receiver 108b of network element 102b, via fiber 103a.

Receiver 108b may include a PBS 216 configured to receive the DP-QPSK signal. PBS 216 may be configured to split the beam carrying the DP-QPSK signal into two modulated components. PBS 216 may direct one of the components to optical hybrid 222b. PBS 216 may direct the other polarized beam to rotator 218, which may be configured to rotate the polarization of the polarized beam. Rotator 218 may be configured to direct the rotated beam to optical hybrid 222a. Alternatively the 90 degree mixer 222a may include a rotation function, or the rotation function may be on the other input port of the 90 degree mixer 222a, or alternatively the rotator 218 may be placed in the path between PBS 216 and 90 degree mixer 222b instead, or the 90 degree mixer 222b may include a rotation function, or the rotation function may be on the other input port of the 90 degree mixer 222b. Other variations may result in substantially same receiver performance and are not essential to this invention.

Receiver 108b may also include a laser 220 configured to act as a local oscillator of receiver 108b. Laser 220 may be configured to transmit a beam of light having approximately the same wavelength as the beam of light transmitted by laser 204 of transmitter 110a, such that receiver 108b may be tuned to receive signals from transmitter 110a. Laser 220 may be configured to direct the beam to Bs 217.

BS 217 may be configured to receive the beam and split it according to two polarization components. BS 217 may direct one polarized beam to hybrid 222a and the other polarized beam to hybrid 222b. Alternatively BS 217 may be replaced by an alternate configuration with a Polarization Beam Splitter (PBS) and appropriately oriented local oscillator beam.

Hybrids 222a and 222b may be configured to mix the states (e.g., quadratural states) of the beams received from laser 220 with the beams associated with the DP-QPSK signal and may respectively send the mixed optical signals to photodetectors 223 configured to convert the optical signals into electrical signals. Following optical-electrical conversion, the signals may be sent to transimpedance amplifiers (TIAs) 224a and 224b.

After amplifying the signals, TIAs 224a and 224b may be configured to direct the signals to analog to digital converters (ADCs) 226a and 226b respectively. ADCs 226a and 226b may be configured to convert the signals from analog to digital form and may direct the digital signals to digital signal processor (DSP) 228. DSP 228 may be configured to perform signal processing of the signals received from ADCs 226a and 226b to process the information that was encoded onto the DP-QPSK signal received from transmitter 110a.

Controllers 120a and 120b, transmitter 110a and receiver 108b may be configured to conserve power consumption for the communication of traffic between network elements 102a and 102b over link 122a via fiber 103a.

For example, as discussed above, transmitter 110a network element 102a may be able to transmit a DP-QPSK modulated optical signal at a maximum specified symbol rate and receiver 108b may be able to read the DP-QPSK modulated signal at the maximum symbol rate. Accordingly, controllers 120a and 120b may be configured to determine that network elements 102 may be capable of transmitting a DP-QPSK signal over link 122a at the maximum specified symbol rate.

Controllers 120a and 120b may also be configured to determine the actual transmission requirements of link 122a. In some instances controllers 120a and 120b may determine that the traffic transmission capabilities of link 122a are greater than the traffic transmission requirements of link 122a. In some instances the transmission capabilities may be substantially greater than the transmission requirements such that the traffic transmission “margin” is greater than a specified threshold. With the traffic transmission margin greater than the specified threshold, controllers 120a and 120b may determine that DP-QPSK modulation is unnecessary.

Based on the traffic transmission margin, controller 120a may direct transmitter 110a to change from DP-QPSK modulation to QPSK modulation. Transmitter 110a may accordingly shut down components associated with modulating information on one of the polarization components and conserve power.

For example, transmitter 110a may shut down drivers 202a and 202b and modulators 210a and 210b such that no information is modulated onto the polarized beam associated with those components. Accordingly, by not running these components, transmitter 110a may conserve power, and the signal transmitted by transmitter 110 may comprise a single polarization QPSK signal. In alternative embodiments, instead of a single polarization QPSK signal being produced, the DP-QPSK modulation may be configured such that the modulation levels in the constellation of a single polarization signal are increased from four to eight to switch to 8-PSK modulation.

Additionally, transmitter 110a may use a variable beam coupler replacing BS 208 to switch the power of laser 204 to one pair of modulators 210a and 210b or 210c and 210d only, which may reduce the required output power of laser 204 to maintain same total signal power at the output of transmitter 110a. In the same or alternative embodiments, transmitter 110a may change the modulation from a return-to-zero to a non-return-to-zero format. Accordingly, transmitter 110a may shut down RZ carver 206 to further conserve power. In addition to shutting down RZ carver 206, laser power can be reduced to maintain same total signal power at the output of transmitter 110a.

Controller 120b may also direct receiver 108b to shut down the components associated with receiving and processing signals associated with the polarization component with no information modulated thereon. For example, receiver 108b may save power by configuring DSP 228 to stop operations associated with processing the signal associated with one principal polarization that does not carry information. The DSP 228 must be suitably configured to be able to process a single-polarization 8-PSK signal as an alternative to single-polarization QPSK.

Controller 120b may also direct receiver 108b to bypass PBS 216 and connect the optical input signal directly to 90 degree hybrid 222a or 222b only, and shut down TIAs 226a and 224a respectively, which may conserve power. Additionally, DSP 228 may be configured to stop operations associated with processing the signals received from ADC 226a or 224a respectively, which may also conserve power. In addition, if BS 217 is replaced by a variable coupler, all optical power from laser 220 may be directed to the 90 degree hybrid 222a or 222b processing an optical signal carrying information, thereby reducing the required output power of laser 220.

Therefore, transmitter 110a and receiver 108b may be configured to change from a more complex modulation format (e.g., DP-QPSK or 8-PSK) to a less complex modulation format (e.g., QPSK) based on the traffic requirements associated with transmitter 110a and receiver 108b. Consequently, by changing modulation formats transmitter 110a and receiver 108b may reduce the power consumption of network elements 102a and 102b respectively.

Modifications, additions or omissions may be made to FIG. 2 without departing from the scope of the present disclosure. For example, although network element 102a is depicted with one transmitter 110a and network element 102b is depicted with one receiver 108b, it is understood that network elements 102 may include one or more transmitters 110 and/or receivers 108. Additionally, it is understood that controllers 120, transmitters 112 and receivers 114 of FIG. 1 (not expressly shown in FIG. 2) of network elements 102 may be configured to perform similar operations with respect to link 122b of FIG. 1. Further, although the present operations have been described with respect to a link between network elements 102a and 102b, it is contemplated that a similar analysis may be done with respect to a path that includes a plurality of links and a plurality of intermediate network elements. Additionally, as described above with respect to FIG. 1, a network management system may be configured to perform one or more of the operations described as being performed by controllers 120.

FIG. 3 illustrates an example system 300 configured to conserve power by adjusting error correction of an optical signal. System 300 may include network elements 102a and 102b of FIG. 1 that may respectively include transmitters 110a and 110b, receivers 108a and 108b, and controllers 120a and 120b. Although not explicitly shown in FIG. 3, network elements 102a and 102b may also respectively include transmitters 112a and 112b, and receivers 114a and 114b, respectively, of FIG. 1.

Network elements 102a and 102b may be configured to implement any suitable error correction scheme to compensate for corruption of an optical signal that may be caused by noise or cross-talk between channels. The error correction may include any suitable method of encoding data to detect and accordingly correct errors in the data. By way of example and not limitation, the error correction may comprise a forward error correction (FEC) scheme to compensate for errors in a signal. The FEC scheme may include a soft decision (SD) or a hard decision (HD) FEC code, any other suitable FEC code, or any combination thereof. In some embodiments, the FEC code may comprise a low density parity check (LDPC) FEC code. The correction code may also comprise a block code such as a Reed-Solomon error correction code.

The correction code of data may comprise a concatenated error code that includes a plurality of “layers” of error correction encoding. Each layer may comprise encoding data with one or more error correction codes such that each added layer may correct errors that may be missed by the previous layer. Layers of error correction encoding may be added for signals that may experience increasing levels of interference from factors such as noise and cross-talk between channels. Accordingly, in instances where a signal propagates a long distance, and thus, experiences more noise, more layers of error correction may be needed to maintain signal integrity. Further, in instances where particular modulation techniques create more cross talk between channels than other modulation techniques, more layers of error correction may be needed for proper signal integrity. Additionally, increased symbol rates may require increased layers of error correction. Conversely, when propagation distances are shorter, modulation techniques are changed, and symbol rates are changed, or any combination thereof, fewer layers of error correction may be needed.

Network elements 102a and 102b may be configured to bypass one or more error correction layers when transmission requirements (e.g., signal propagation distance, modulation and symbol rates) allow for fewer layers. Each layer of error correction may utilize different components of network elements 102a and 102b, require additional processing functions, or any combination thereof, that may each consume power. Accordingly, network elements 102a and 102b may be configured to conserve power by bypassing one or more error correction layers when transmission parameters allow.

In the present embodiment, network elements 102a and 102b may each include an inner encoder 304 and an outer encoder 306 configured to provide a plurality of layers of error correction encoding to signals transmitted by transmitters 110. Network elements 102a and 102b may each also include an outer decoder 308 and an inner decoder 310 configured to perform error correction decoding. As described in further detail below, network elements 102a and 102b may be each configured to disable at least one of an inner encoder 304, an outer encoder 306, an outer decoder 308 and an inner decoder 310 to conserve power in instances where one or more layers of error encoding may be bypassed.

Network element 102a may include a transmitter (Tx) framer 302a that comprises and suitable system, apparatus or device configured to generate frames or packets of data that are to be transmitted through an optical network. Transmitter framer 302a may be communicatively coupled to inner encoder 304a and may be configured to send the data frames to inner encoder 304a. A framer is a function or device that packages a portion of data into the payload section of a frame and adds overhead information into the header section of a frame. For example, in an ITU-T G.709 optical transport network a payload is encapsulated in multiple stages into an OTU frame. The OUT frame includes space for FEC overhead data, which is FEC information that may be used to detect and correct transmission errors on the receiver side.

Inner encoder 304a may comprise any suitable system, apparatus or device configured to receive one or more data frames from transmitter framer 302a and encode the frames with an error correction code. In the present example, inner encoder 304a may encode a frame with an SD-FEC code such as a LDPC FEC code. Inner encoder 304a may be communicatively coupled to outer encoder 306a and may be configured to transmit the encoded frame of data to outer encoder 306a.

Outer encoder 306a may comprise any suitable system, apparatus or device configured to add a layer of correction coding to a frame received from inner encoder 304a. In the present example, outer encoder 306a may be configured to apply a hard definition block code such as a Reed-Solomon (RS) code to a frame received from inner encoder 304a. Outer encoder 306a may be configured to send the encoded frame to transmitter 110a. Transmitter 110a may modulate the encoded frame on an optical signal and may transmit the optical signal to receiver 108b via fiber 103a.

It is understood that the terms “inner” and “outer” are merely used to denote that inner encoder 304a may add error detection and correction overhead to frames received from transmitter framer 302a and that outer encoder 306a may add another block of overhead data to frames generated by transmitter framer 302a including the overhead from the inner FEC, such that there may be an “inner” layer of forward error correction coding and an “outer” layer of forward error correction coding. It is also understood that even though two FEC encoders are depicted, network element 102a may have more or fewer encoders than those depicted. For example, the inner and outer encoding may be done by a single encoder instead of the two separate encoders depicted. Additionally, although two layers of error correction encoding are depicted, it is understood that network element 102a may be configured to apply additional layers of forward error correction encoding via inner encoder 302a, outer encoder 304a, other encoders not shown, or any combination thereof. In addition, the framer function may be combined with one or more FEC encoders and any suitable framing method may be used. without changing the essence of this invention,

Network element 102a may also include receiver 108a, an outer decoder 308a, an inner decoder 310a and a receiver (Rx) framer 312a similarly configured as receiver 108b, outer decoder 308b, inner decoder 310b and receiver framer 312b of network element 102b, as described below.

As mentioned above, receiver 108b of network element 102b may receive an encoded optical signal from transmitter 110a. Network element 102b may also include an outer decoder 308b and an inner decoder 310b configured to decode the error correction encoding of optical signals received at receiver 108b. After converting the optical signal to an electrical signal, receiver 108a may transmit the encoded electrical signal to outer decoder 308b.

Outer decoder 308b may comprise any suitable system, apparatus or device configured to receive data including an error correction code overhead and correct any errors in the received data. In the present example, the electrical signal received by outer decoder 308b from receiver 108a may have been encoded by inner encoder 304a and outer encoder 306a. Accordingly, outer decoder 308b may be configured to perform the error correction enabled by outer encoder 306a of network element 102a (e.g., a RS block code). Following error correction decoding, outer decoder 308b may send the signal to inner decoder 310b.

Inner decoder 310b may comprise any suitable, system, apparatus or device configured to receive data with an error correction code overhead and correct any errors in the received data. In the present example, inner decoder 310b may be configured to decode the error correction done by inner encoder 304a of network element 102a (e.g., decode the LDPC FEC code). Accordingly, in the present example, with both layers of error correction decoded, inner decoder 310b may transmit the decoded signal to receiver (Rx) framer 312b. Receiver framer 312b may be configured to process the data included in decoded signal (e.g., deconstruct the data frame).

Network element 102b may also include a transmitter framer 302b, inner encoder 304b, outer encoder 306b and transmitter 110b similarly configured as transmitter framer 302a, inner encoder 304a, outer encoder 306a and transmitter 110a.

Network elements 102a and 102b may also include controllers 120a and 120b respectively. Controllers 120 may be communicatively coupled to their respective inner encoders 304, outer encoders 306, outer decoders 308 and inner decoders 310 (coupling is not expressly shown). Controllers 120 may accordingly be configured to communicate power saving schemes to their respective encoders and decoders such that the encoders and decoders may implement the schemes.

As described above, controllers 120a and 120b may be configured to determine whether one or more layers of error correction may be bypassed to conserve power and may accordingly direct network elements 102a and 102b to respectively bypass one or more error correction layers. For example, controller 120a may determine that the transmission distance, modulation scheme, and/or symbol rate for link 122a may be such that multiple layers of error correction are not necessary. Alternatively or in addition controller 120a may use information such as error rates before and/or after the outer decoder 308a and/or measurement information relevant to the path over which information is received. Accordingly, controller 120a may determine that error correction encoding by inner encoder 304a may be unnecessary. Controller 120a may consequently instruct inner encoder 304a to shut down (to bypass) and not encode error correction data into frames from transmitter framer 302a. Therefore, energy may be conserved by shutting down inner encoder 304a.

In such instances, the data frames from transmitter framer 302a may bypass or pass through inner encoder 304a without being encoded and may be received by outer encoder 306a. Outer encoder 306a may encode the data frames received from transmitter framer 302a with a first layer of error correction encoding. Outer encoder 306a may transmit the encoded data to transmitter 110a, which may transmit an optical signal with a single layer of error correction to receiver 108b.

Receiver 108b may receive the optical signal with a single layer of error correction from transmitter 110a, and may transmit the corresponding electrical signal to outer decoder 308b. Outer decoder 308b may decode the encoding done by outer encoder 306a. Controller 120b may be configured to shut down (to bypass) inner decoder 310b in network element 102b due to inner encoder 304a being shut down in network element 102a, thus conserving power. Accordingly, with the signal entirely decoded by outer decoder 308b (due to no encoding done by inner encoder 304a), the signal may bypass or pass through inner decoder 310b without inner decoder 310b performing any operations, and may be sent to receiver framer 312b.

In alternative embodiments, outer encoder 306a and outer decoder 308b may be shut down and bypassed while inner encoder 304a and inner decoder 310b perform error corrections. Additionally, although not specifically described, outer decoder 308a and inner decoder 310a of network element 102a may be configured to reduce layers of error correction if the parameters (e.g., transmission distance, modulation, symbol rate, etc.) associated with their corresponding link allow. Further, inner encoder 304b and outer encoder 304b of network element 102b may be similarly configured to reduce layers of error correction if the parameters associated with their corresponding link also allow. Therefore, network elements 102a and 102b may be configured to reduce unnecessary power consumption of network elements 102a and 102b.

Modifications, additions or omissions may be made to system 300 without departing from the scope of the present disclosure. For example, although network elements 102 are depicted as generating two layers of error correction and shutting down one layer to conserve power, it is understood that network elements 102 may be configured to generate or shut down any number of layers of error correction.

Further, although network element 102a is depicted with one transmitter 110a and one receiver 108a and network element 102b is depicted with one receiver 108b and one transmitter 110b, it is understood that transponders 116 may include one or more transmitters 110 and/or receivers 108. Additionally, it is understood that controllers 120 of network elements 102 (not expressly shown) may be configured to perform similar operations with respect to link 122b of FIG. 1. It is also understood that although certain operations are depicted as being done by certain components included in certain areas of network elements 102, more or fewer components may perform the operations described, and may be included in other areas of network elements 102 than those specifically depicted. Further, although the present operations have been described with respect to link 122a between network elements 102a and 102b, it is contemplated that a similar analysis may be done with respect to a path that includes a plurality of links and a plurality of intermediate network elements. Additionally, as described above with respect to FIG. 1, a network management system may be configured to perform one or more of the operations described as being performed by controllers 120.

FIG. 4 illustrates a method 400 for conserving power by a network element. In the present embodiment the steps of method 400 are described as being implemented by a network element, such as network elements 102a and 102b of FIGS. 1-3. It is understood that any suitable component of the network element may perform one or more of the operations described. For example, controllers, transmitters, receivers, error correction encoders and/or error correction decoders may each perform various operations and steps of method 400. Additionally, in some instances a network management system may perform one or more steps of method 400

Method 400 may start at step 402 where a network element may determine the transmission capabilities of a link associated with the network element. The transmission capabilities may include transmission distance, traffic capabilities (e.g., symbol rates, data rates, modulation formats, etc.) or any combination thereof. At step 404, the network element may determine the transmission requirements of the link. Steps 402 and 404 may be performed in any order, including simultaneously without departing from the scope of the present disclosure.

At step 406, the network element may determine the transmission capability margin of the link. As mentioned previously, the capability margin may comprise the difference between transmission capabilities and transmission requirements. The margin may indicate a difference associated with distance, traffic requirements or any combination thereof.

At step 408, the network element may determine whether the transmission margin is greater than a certain threshold. If the margin is not greater than the threshold, method 400 may return to step 404. Alternatively method 400 may terminate in case of a static system. Method 400 is used when link capabilities change, or when link requirements change. Link capabilities may depend on other signals being carrier over the same link, for example at a neighboring wavelength. If the margin is greater than the threshold, method 400 may proceed to step 410.

At step 410, based on the transmission margin, the network element may change the modulation associated with the link. For example, if the transmission margin indicates that traffic transmission requirements are sufficiently low, the network element may transmit a QPSK modulated signal instead of a DP-QPSK signal. By transmitting a QPSK signal instead of a DP-QPSK signal, the network element may conserver power.

At step 412, based on the transmission margin, the network element may reduce the symbol rate if the traffic transmission requirements are sufficiently low. In some instances, both steps 412 and 410 may be implemented if the margin is substantially large enough and in other instances, either step 410 or step 412 may be implemented.

At step 414, based on at least one of the transmission margin, the modulation and the symbol rate, the network element may reduce error correction by, for example, reducing the number of error correction encoding layers. In some instances the transmission margin may indicate that the actual transmission distance over a link is sufficiently shorter than the transmission distance capability such that a layer of error correction may be bypassed. In the same or alternative instances, where the modulation is changed in step 410 and less cross talk results, network element may also reduce the number of error correction layers. Additionally, in instances where the symbol rate is decreased in step 412 and fewer errors are introduced, the network element may reduce the number of error correction layers.

The error correction reduction in step 414 may be based on a single one of the above mentioned factors or any combination thereof. For example, in some instances the error correction may be based on a distance margin and the modulation and symbol rate may not change. Accordingly, steps 410 and 412 may be skipped and method 400 may move from step 408 to step 414. Following step 414, the method may end.

Modifications, additions or omissions may be made to method 400 without departing from the scope of the present disclosure. For example, the steps may be performed in a different order than those described, and some steps may be performed simultaneously, or in series. Further, more or fewer steps may be included to method 400.

Although the present disclosure and its advantages have been described in detail, it should be understood that various changes, substitutions and alterations can be made herein without departing from the spirit and scope of the disclosure as defined by the following claims.

What is claimed is:

1. A method for conserving power in an optical network comprising:
determining a signal transmission capability of a first network element optically coupled to a second network element over an optical network, the first network element configured to transmit an optical signal to the second network element over a path associated with the optical network;
determining a transmission requirement of the path between the first and second network elements;
determining a difference between the transmission capability and the transmission requirement; and
changing at least one of error correction and modulation associated with the optical signal transmitted based on the difference between the transmission capability and the transmission requirement, to reduce power consumption of at least one of the first network element and the second network element.

2. The method of claim 1, wherein changing at least one of error correction and modulation further comprises bypassing one of two or more layers of error correction to reduce power consumption of at least one of the first network element and the second network element.

3. The method of claim 1, wherein changing at least one of error correction and modulation further comprises changing the modulation of the signal from a dual polarization modulation to a single polarization modulation and doubling the numbers of bits per symbol per polarization to reduce power consumption of at least one of the first network element and the second network element.

4. The method of claim 3, further comprising shutting down at least one of a driver and signal processing circuit section associated with the dual polarization modulation.

5. The method of claim 1, wherein changing at least one of error correction and modulation further comprises changing the modulation of the signal from one modulation to a different modulation while maintaining the number of bits per symbol to reduce power consumption of at least one of the first network element and the second network element by shutting down at least one of a driver, receiver and digital signal processing (DSP) circuit section.

6. The method of claim 5, wherein at least one of the modulator and receiver is configured to redirect or re-partition continuous wave laser light to an optical modulation circuit or receiving circuit section based on the desired modulation.

7. The method of claim 1, further comprising comparing the difference between the transmission capability and the transmission requirement with a threshold value, and, if the difference between the transmission capability and the transmission requirement is greater than the threshold value, changing at least one of the error correction and modulation.

8. The method of claim 1, further comprising reducing a symbol rate of the optical signals based on the difference between the transmission capability and the transmission requirement and wherein changing at least one of error correction and modulation further comprises bypassing one of two or more layers of error correction to reduce power consumption in response to reducing the symbol rate.

9. The method of claim 1, wherein changing at least one of error correction and modulation further comprises disabling a return to zero pulse carver configured to provide a return to zero modulation of the optical signal.

10. The method of claim 1, wherein changing at least one of error correction and modulation further comprises bypassing encoding the signal with a soft decision (SD) low density parity check (LDPC) forward error correction (FEC) code and encoding the signal with a hard decision (HD) FEC block code.

11. A system comprising:
a transmitter configured to transmit an optical signal from a first network element to a second network element over a path associated with an optical network; and
a controller configured to:
determine a signal transmission capability of the first network element with respect to the optical signal;
determine a transmission requirement of the path between the first and second network elements;
determine a difference between the transmission capability and the transmission requirement; and
change at least one of error correction and modulation associated with the optical signal transmitted based on the difference between the transmission capability and the transmission requirement, to reduce power consumption of at least one of the first network element and the second network element.

12. The system of claim 11, wherein the controller is further configured to change at least one of error correction and modulation by bypassing one of two or more layers of error correction to reduce power consumption of at least one of the first network element and the second network element.

13. The system of claim 11, wherein the controller is further configured to change at least one of error correction and modulation by changing the modulation of the signal from a dual polarization modulation to a single polarization modulation and doubling the numbers of bits per symbol per polarization to reduce power consumption of at least one of the first network element and the second network element.

14. The system of claim 13, wherein the controller is further configured to shut down at least one of a driver and signal processing associated with the dual polarization modulation.

15. The system of claim 11, wherein the controller is further configured to change the modulation of the signal from one modulation to a different modulation while maintaining the number of bits per symbol to reduce power consumption of at least one of the first network element and the second network element by shutting down at least one of a driver, receiver and digital signal processing (DSP) circuit section.

16. The system of claim 15, wherein the controller is further configured to change the modulation of the signal from a dual polarization modulation to a single polarization modulation and double the numbers of bits per symbol per polarization to reduce power consumption of at least one of the first network element and the second network element

17. The system of claim 11, wherein the controller is further configured to:
compare the difference between the transmission capability and the transmission requirement with a threshold value; and
change at least one of the error correction and modulation if the difference between the transmission capability and the transmission requirement is greater than the threshold value.

18. The system of claim 11, wherein the controller is further configured to:
reduce a symbol rate of the optical signal based on the difference between the transmission capability and the transmission requirement; and
change at least one of error correction and modulation by bypassing one of two or more layers of error correction to reduce power consumption in response to reducing the symbol rate.

19. The system of claim 11, wherein the controller is further configured to change at least one of error correction and modulation by disabling a return to zero pulse carver configured to provide a return to zero modulation of the optical signal.

20. The system of claim 11, wherein the controller is further configured to change at least one of error correction and modulation by bypassing encoding the signal with a soft decision (SD) low density parity check (LDPC) forward error correction (FEC) code and encoding the signal with a hard decision (HD) FEC block code.

21. The system of claim 11, wherein the controller is further configured to determine at least one of the signal transmission capability, the transmission requirement of the path, and the difference between the transmission capability and the transmission requirement by receiving, from a network management system, information indicating at least one of the signal transmission capability, the transmission requirement of the path, and the difference between the transmission capability and the transmission requirement.
